(19) United States
(12) Patent Application Publication
(10) Pub. No.: US 2013/0126563 A1
(43) Pub. Date: May 23, 2013

(54) Baby Bottle Holder

(71) Applicant: Angel Clark Henry, New Orleans, LA (US)

(72) Inventor: Angel Clark Henry, New Orleans, LA (US)

(21) Appl. No.: 13/630,636

(22) Filed: Sep. 28, 2012

Related U.S. Application Data
(60) Provisional application No. 61/561,526, filed on Nov. 18, 2011.

(51) Int. Cl. A61J 9/06

(52) U.S. Cl. 224/148.5

(57) ABSTRACT

The present invention is a baby bottle holding apparatus and a method of use thereof which allow the wearer to conveniently bottle-feed a baby in closeness and comfort similarly found in breastfeeding. Particularly, the present invention allows the wearer to utilize only one hand in bottle-feeding the baby while utilizing the free hand to perform other manual tasks. The apparatus is to be worn around the thorax with the baby bottle pouch positioned centrally upon the chest of the wearer. With the bottle pouch positioned upon the chest, the user may insert a baby bottle into the pouch with the bottle nipple shown and visible to the baby. The bottle is secured to the pouch via a drawstring or an elastic band. The strap of the apparatus is adjustable in length. Beside the bottle, the baby may also play with a toy attached to the strap via a string.

The current application claims a priority to the U.S. Provisional Patent application Ser. No. 61/561,526 filed on Nov. 18, 2011.

### FIELD OF THE INVENTION

The present invention relates generally to a baby bottle holding apparatus and a method of use thereof. Specifically, the baby bottle holding apparatus is utilized to carry a baby bottle to allow the wearer to feed the infant while utilizing his or her free hand to perform other manual tasks.

### BACKGROUND OF THE INVENTION

When feeding an infant or a baby, a bottle is normally utilized. One of the prevalent problems of using a baby bottle is the caregiver must use both hands with one hand holding the bottle while the other hand clutching the baby close during feeding. The traditional technique of utilizing the baby bottle forces the caregiver to use both hands. Consequently, the child bearer is not hands-free to perform other manual tasks. It is therefore an object of the present invention to provide an apparatus and a method of use thereof for conveniently carrying a baby bottle while allowing bottle feeding in closeness and comfort similarly found in breastfeeding. It is also another object of the present invention to provide a baby bottle holder which is to remain stationary upon the chest of the wearer so the wearer may only use one hand in feeding the baby while utilizing the other hand in performing other manual tasks.

### BRIEF DESCRIPTION OF THE DRAWINGS

FIG. 1 is a functional view of the preferred embodiment of the present invention.

FIG. 2 is an upright view of the preferred embodiment of the present invention.

FIG. 3 is a cross-sectional view of an alternative preferred embodiment wherein threading is used as a bottle locking mechanism.

FIG. 4 is a cross-sectional view of an alternative preferred embodiment wherein snapping is used as a bottle locking mechanism.

FIG. 5 is a cross-sectional view of an alternative preferred embodiment wherein strapping is used as a bottle locking mechanism.

FIG. 6 is another functional view of the preferred embodiment illustrating the versatility of the shape of the pouch.

FIG. 7 is an overall view of the alternative embodiment of the present invention wherein the strap is connected to the pouch.

### DETAILED DESCRIPTION OF THE INVENTION

All illustrations of the drawings are for the purpose of describing selected versions of the present invention and are not intended to limit the scope of the present invention.

The present invention is a baby bottle holder which primarily comprises a baby bottle pouch 1 and an at least one adjustable strap 2. The baby bottle pouch 1 is wherein a baby bottle is to be positioned and strapped to during usage of the present invention. The present invention is to be worn across the chest of a caregiver while allowing the caregiver to not utilize both arms or hands in bottle feeding the infant. Thus, with the present invention adorned, at least one hand of the wearer is free to perform other manual tasks. The present invention comprises at least two embodiments and a method of use thereof.

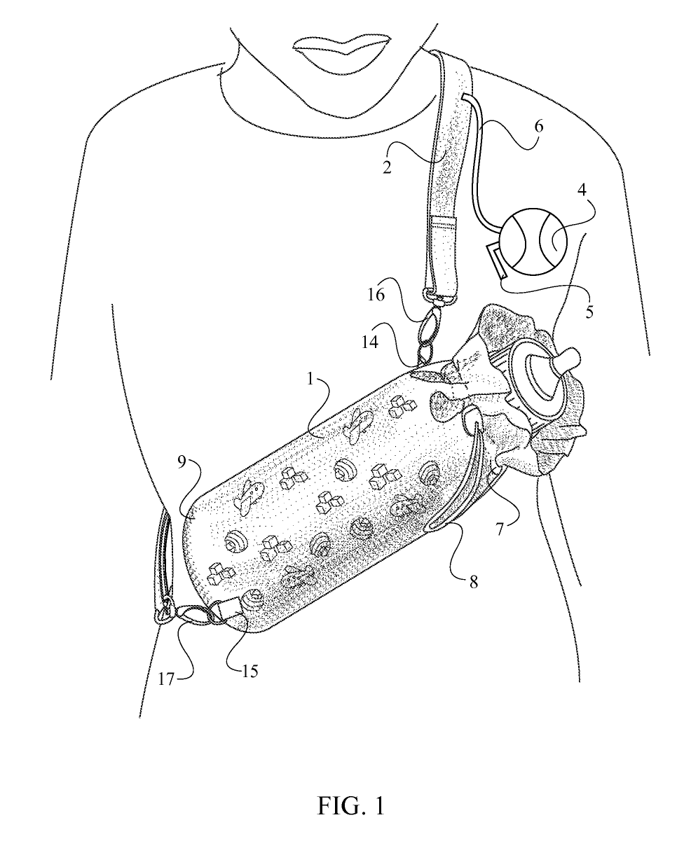

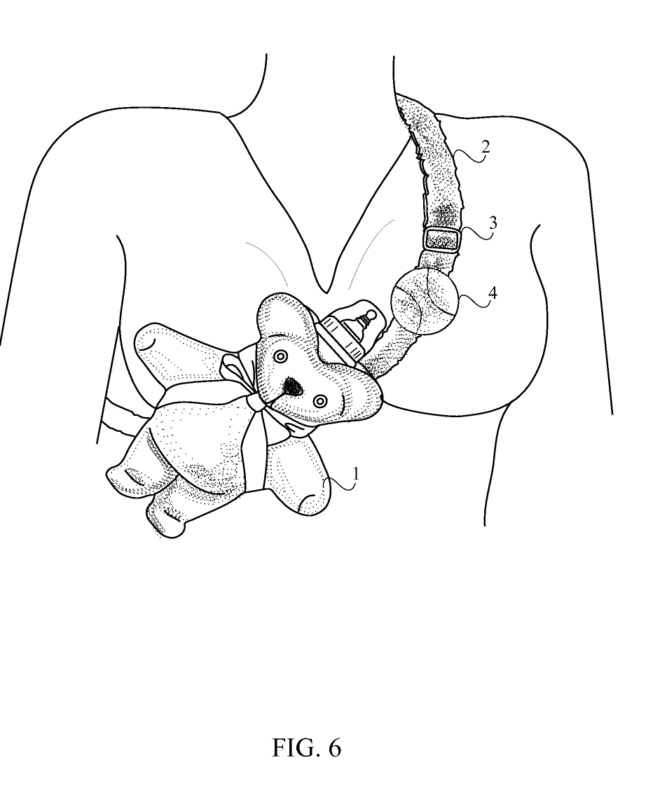

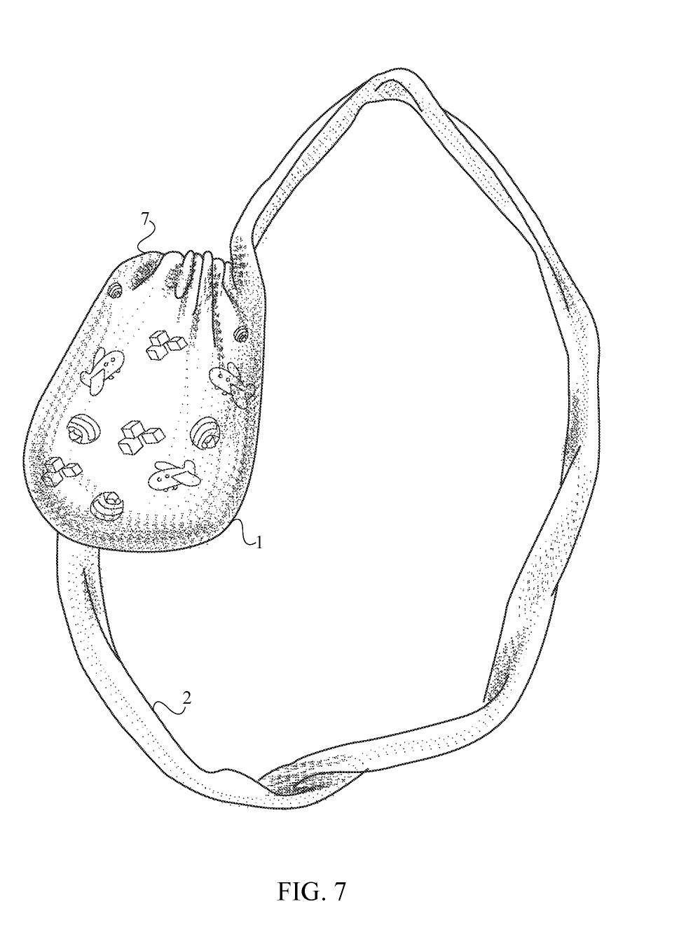

In the preferred embodiment, each of the attachment mechanisms between the at least one adjustable strap 2 and the baby bottle pouch 1 comprises components selected from the group consisting of clips, hooks, loops, rings, clasps, and fasteners. It is also understood that the attachment mechanisms are composed of any non-toxic, non-abrasive, durable elastic material. In the alternative embodiment of the baby bottle holder, the baby bottle pouch 1 and the at least one adjustable strap 2 are continuously connected as shown in FIG. 7. As shown in FIG. 7, both the baby bottle pouch 1 and the at least one adjustable strap 2 are continuously and permanently connected in a manner wherein both the baby bottle pouch 1 and the at least one adjustable strap 2 form a closed loop. The difference between the preferred embodiment and the alternative embodiment of the present invention is the preferred embodiment incorporates attachment mechanisms between at least one adjustable strap 2 and the baby bottle pouch 1. Due to the inclusion of these attachment mechanisms to the present invention in the preferred embodiment, both the baby bottle pouch 1 and the at least one adjustable strap 2 are thus removably attached to and detached from each other. The at least one adjustable strap 2 is to be wrapped around a shoulder of the user so the apparatus may hold the baby bottle upon and across the chest of the user as shown in FIG. 1 and FIG. 6. The baby bottle pouch 1 containing the baby bottle can be sewn onto the at least one adjustable strap 2 or permanently attached thereto as shown in the alternative embodiment in FIG. 7. Conversely, the baby bottle pouch 1 may be removably attached to or detached from the at least one adjustable strap 2 as shown from FIG. 1 to FIG. 6. The present invention includes any desired means of detaching the baby bottle pouch 1 from the at least one adjustable strap 2.

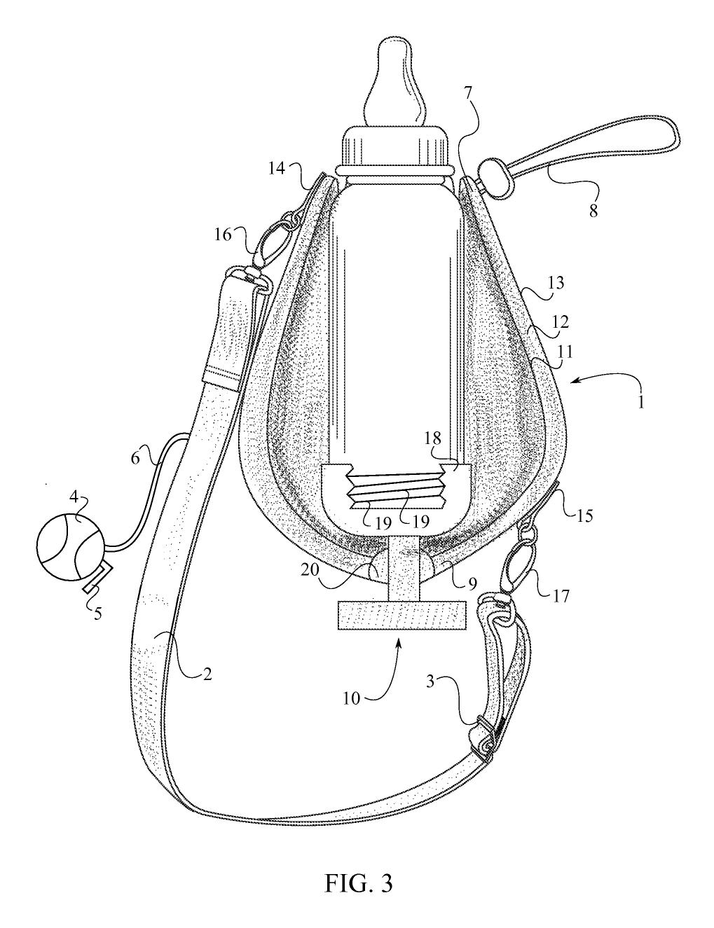

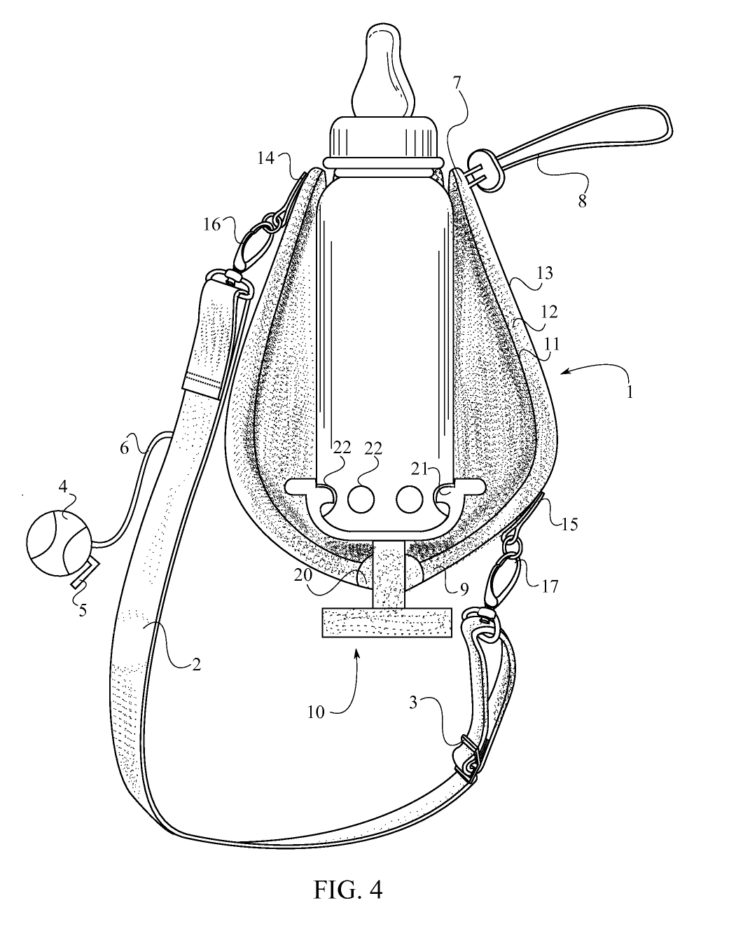

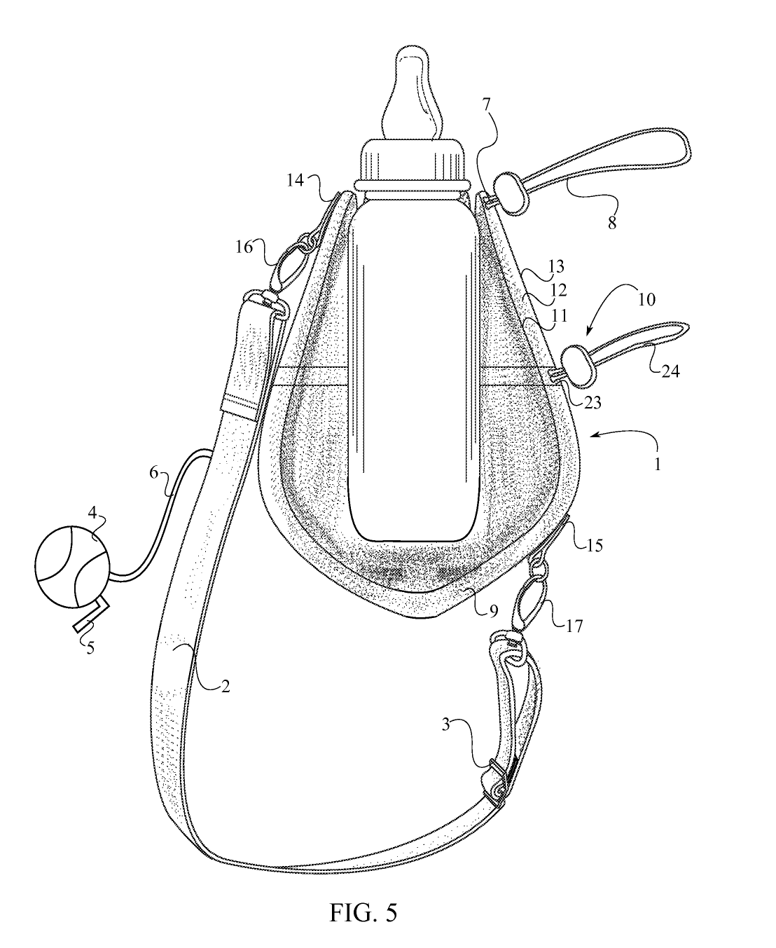

Since the primary users of the present invention are infants, it is paramount the entirety of the present invention be made of safe, non-toxic, and comforting materials suitable for babies. The baby bottle pouch 1 and the at least one adjustable strap 2 are made of a soft fabric material. The soft fabric material comprises components selected from the group consisting of cotton, fleece, leather, a combination thereof, and other soft materials. During use, the infant will come in contact with both the baby bottle and the baby bottle pouch 1 repeatedly. Therefore, the baby bottle pouch 1 needs to be composed of soft and comforting materials. In the present invention, the baby bottle pouch 1 may comprise more than one layer. Specifically, the baby bottle pouch 1 comprises a lining layer 11, a filling layer 12, and an external cover 13 as shown in FIG. 3, FIG. 4, and FIG. 5. The lining layer 11 of the baby bottle pouch 1 is a thin layer made of a strong, resilient, and flexible material. The space created between the lining layer 11 and the external cover 13 of the baby bottle pouch 1 is the filling layer 12, which is to be filled with soft and comforting fill materials such as cotton, felt, wool, fur, velvet, velveteen, velour, chenille, and the like. Because of the soft materials contained within the filling layer 12, the baby bottle pouch 1 is thus soft and comforting for the infant to touch and caress. The soft and comforting sensation of the filling layer 12 serves to be similar to the soft sensation that of a stuffed animal such as a teddy bear. The external cover 13 of the baby bottle pouch 1 serves as the outermost layer of the baby bottle pouch 1. Furthermore, the external cover 13 serves as a decorative coating layer which is also made of a soft, comforting, and flexible material. In both the preferred embodiment and the alternative embodiment, the external cover 13 conforms to the shape of the baby bottle, but it is understood that the external cover 13 of the baby bottle pouch 1 may be of various shapes. The shapes include but are not limited to oval, circle, square, rectangle, and an irregular shape. The shapes further include animal shapes and customized shapes as shown in FIG. 6. Specifically, the shape of the external cover 13 can be customized to any shape to fit the needs of the infant or the caregiver. As illustrated in FIG. 6, the external cover 13 of the present invention may be in a shape of a teddy bear with a comforting fur coating for the infant to touch. In addition to being variably embodied, the external cover 13 may be decorated with various decorative designs attractive to infants. These various decorative designs include but are not limited to flowers, butterflies, stars, spaceships, trains and other simple objects. Furthermore, these decorative designs are preferably in soothing and comforting light colors such as baby blue and light pink.

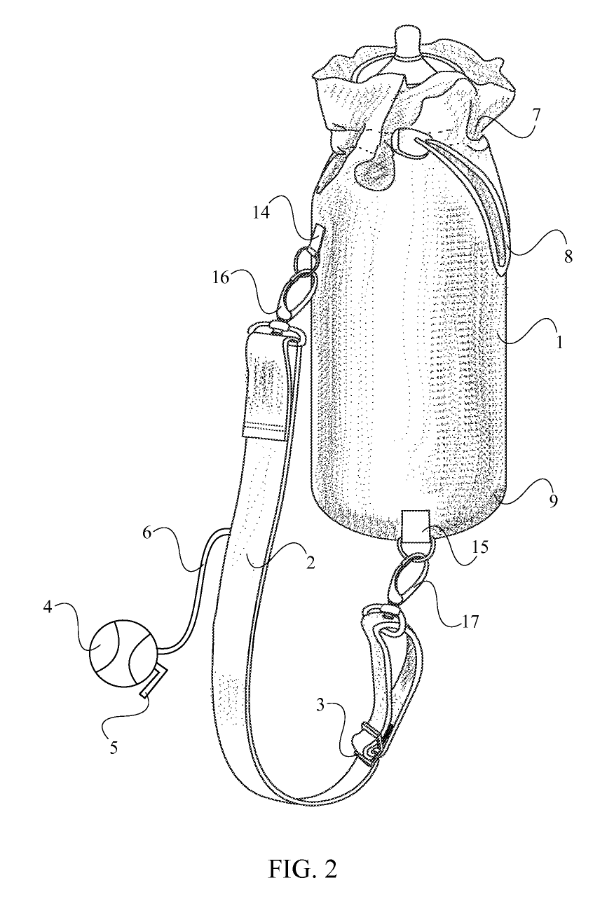

In addition to the comforting layers, the baby bottle pouch 1 also comprises an adjustable open end 7, a drawstring 8, a bottle locking mechanism 10, and a pouch base 9 as shown in FIG. 2. The adjustable open end 7 has been made adjustable due to an attachment of the drawstring 8 thereto. Specifically, the drawstring 8 is longitudinally sheathed by the adjustable open end 7. The adjustable open end 7 of the baby bottle pouch 1 is the hem of the baby bottle pouch 1 that has been attached to itself while creating a hollow tube situated along the circumference of the baby bottle pouch 1. With the drawstring 8 traversing through the hollow space of the adjustable open end 7, the adjustable open end 7 of the baby bottle pouch 1 is thus retractable when the user pulls on the drawstring 8. After traversing through the hollow space of the adjustable open end 7, the two ends of the drawstring 8 come together on one side of the adjustable open end 7. In other drawstring variations, there may be more than one drawstring traversing through the hollow body of the adjustable open end 7 with each drawstring emerging out individually from the adjustable open end 7. In other embodiments of the present invention, an elastic band may be in place of the drawstring 8. Similar to the drawstring 8, the elastic band provides retractability to the circumference of the adjustable open end 7 of the baby bottle pouch 1. Similar to the drawstring 8, the elastic band would also traverse through the hollow tube within the adjustable open end 7 of the baby bottle pouch 1.

In addition to the adjustable open end 7, the baby bottle pouch 1 also comprises a pouch base 9, which serves as a bottom base of the baby bottle pouch 1 whereupon the baby bottle situates. Similar to the body of the baby bottle pouch 1, the pouch base 9 also comprises the lining layer 11, the filling layer 12, and the external cover 13. Additionally, the pouch base 9 comprises the bottle locking mechanism 10 whereto the baby bottle is to be engaged. As shown in FIG. 3, FIG. 4, and FIG. 5, the bottle locking mechanism 10 provides secure engagement to the baby bottle once the baby bottle is situated within the baby bottle pouch 1. With provided securement from the bottle locking mechanism 10, the baby bottle will not fall out of the baby bottle pouch 1 when the infant plays with the bottle or when the caregiver stoops over.

In the preferred embodiment of the present invention, the bottle locking mechanism 10 can be embodied in various different ways. Specifically, the bottle locking mechanism 10 is positioned upon the pouch base 9, within the baby bottle pouch 1. The bottle locking mechanism 10 can be any one of various bottle locking mechanism 10s include but are not limited to threading, snapping, and strapping. In threading as shown in FIG. 3, the bottom of the baby bottle is threaded with a plurality of threads 19 along with an attachment mechanism in shape of a cup. Specifically, the cup is a threaded cup 18. The inside wall of the threaded cup 18 is threaded so the threaded cup 18 can be attached to the bottom of the baby bottle, which has the plurality of threads 19 attached to the circumference thereof. In the embodiment with the threaded cup 18, the vertical stem of the cup traverses through a pouch hole 20 located at the pouch base 9. Specifically, the pouch hole 20 traverses centrally through the pouch base 9. Connected horizontally to the vertical stem of the threaded cup 18, opposite to the bottom of the baby bottle is a horizontal stem, which helps the user to twist the threaded bottom of the baby bottle and the threaded cup 18 to either engage the baby bottle to the threaded cup 18 or disengage the baby bottle from the threaded cup 18. In snapping as shown in FIG. 4, the bottom of the baby bottle comprises a plurality of circumferential indents 22, which are to be engaged to an attachment mechanism also in shape of a cup whose inner wall comprises a plurality of protrusions, which are to be locked into the plurality of circumferential indents 22 located laterally around the circumference of the bottom of the baby bottle. Similar to threading, the cup in snapping also possesses a vertical stem and a horizontal stem and is called a snapping cup 21. The vertical stem traverses through the pouch base 9 via the pouch hole 20 located at the pouch base 9. Similar to the threading, the pouch hole 20 in snapping also traverses through the pouch base 9. The horizontal stem is attached to the bottom tip of the vertical stem in the similar manner as previously mentioned in threading. The bottom tip of the vertical stem is attached to the midsection of the horizontal stem. The horizontal stem allows the user to hold onto the snapping cup 21 while the plurality of the circumferential indents being engaged to the plurality of protrusions on the snapping cup 21. Conversely, the user may hold onto the snapping cup 21 while the bottom of the baby bottle is being disengaged from the snapping cup 21. In strapping as shown in FIG. 5, there is no hole traversing through the pouch base 9, but the baby bottle pouch 1 comprises a hollow sleeve 23 and an extra drawstring 24 located at the midsection of the baby bottle pouch 1 to keep the body of the baby bottle attached therein. Similar to the drawstring 8, the extra drawstring 24 also traverses through the hollow sleeve 23 around the circumference of the baby bottle pouch 1. The extra drawstring 24 can be replaced by an elastic band. In strapping, any baby bottle may be used, but in threading and snapping, only specialized baby bottles with threads and circumferential indents are used.

In the preferred embodiment of the present invention, there is an upper attachment mechanism 14 such as a ring or a hook attached to the adjustable open end 7 of the baby bottle pouch 1 since the adjustable open end 7 is situated at the top end of the baby bottle pouch 1. Correspondingly, there is a lower attachment mechanism 15 such as a ring or a hook attached to the external cover 13 of the pouch base 9 since the pouch base 9 is situated at the bottom end of the baby bottle pouch 1. Both the upper attachment mechanism 14 and the lower attachment mechanism 15 of the baby bottle pouch 1 serve as attachment points for the at least one adjustable strap 2 to be attached thereto as shown from FIG. 1 to FIG. 5. Particularly, a first end of the at least one adjustable strap 2 is removably attached to the upper attachment mechanism 14 of the baby bottle pouch 1 whereas a second end of the at least one adjustable strap 2 is removably attached to the lower attachment mechanism 15 of the baby bottle pouch 1. In order to securely attach itself to the upper attachment mechanism 14 of the baby bottle pouch 1, the first end of the at least one adjustable strap 2 is also attached to a first end attachment mechanism 16. Similarly, the second end of the at least one adjustable strap 2 is also attached to a second end attachment mechanism 17. Both the first end attachment mechanism 16 and the second end attachment mechanism 17s allow secure attachment of the first end of the at least one adjustable strap 2 to the upper attachment mechanism 14 and the second end of the at least one adjustable strap 2 to the lower attachment mechanism 15. All the four attachment mechanisms of the present invention in the preferred embodiment allow the baby bottle pouch 1 to be easily removable from the at least one adjustable strap 2. Conversely, the four aforementioned attachment mechanisms also allow the at least one adjustable strap 2 to be easily removable from the baby bottle pouch 1.

In addition to comprising wide range of attachment mechanisms, the at least one adjustable strap 2 further comprises an adjustable length. Specifically, the adjustable length comprises a tri-glide slide 3 as shown from FIG. 2 to FIG. 6. A first end of the adjustable length is also the first end of the at least one adjustable strap 2. Therefore, the first end of the adjustable length is attached to the upper attachment mechanism 14 via the first end attachment mechanism 16. Specifically, the first end of the adjustable length traverses through the first end attachment mechanism 16, forms a loop around thereof, and is stitched to itself. A second end of the adjustable length traverses through the tri-glide slide 3 by wrapping around a center bar thereof and emerging out therefrom. After emerging out from the tri-glide slide 3, the second end of the adjustable length traverses through the second end attachment mechanism 17 and loops itself back around the center bar of the tri-glide slide 3 and is stitched to itself. Therefore, the second end of the adjustable length is permanently connected to the center bar of the tri-glide slide 3, leaving the adjustable length loosely traversing through the second end attachment mechanism 17.

While the first end of the adjustable length is permanently attached or connected to the first end attachment mechanism 16, the adjustable length is variably attached to the second end attachment mechanism 17 as the adjustable length is merely traversing therethrough. As the second end of the adjustable length is permanently attached or connected to the center bar of the tri-glide slide 3, the tri-glide slide 3 is therefore able to slide along the length of the adjustable length with the adjustable length traversing through the tri-glide slide 3 and emerging out therefrom. With the tri-glide slide 3 being at different possible linear positions along the at least one adjustable strap 2, the length of the adjustable length and the at least one adjustable strap 2 is therefore variable and adjustable. The length of the adjustable length is varied by the user changing the position of the tri-glide slide 3 along the adjustable length. In conjunction with the baby bottle pouch 1, the at least one adjustable strap 2 forms a closed loop wrapped around the thorax of the user. The circumference of the closed loop formed by the at least one adjustable strap 2 and the baby bottle pouch 1 is variable due to the adjustments made by the user to the at least one adjustable strap 2 via the tri-glide slide 3. For example, the circumference can be decreased by the user sliding the tri-glide slide 3 toward the upper attachment mechanism 14 of the baby bottle pouch 1. Conversely, the circumference can be increased by the user sliding the tri-glide slide 3 toward the lower attachment mechanism 15 of the baby bottle pouch 1. Overall, the circumference of the closed loop created by the at least one adjustable strap 2 and the baby bottle pouch 1 is adjustable by the user varying the position of the tri-glide slide 3 along the at least one adjustable strap 2.

Another variation of the preferred embodiment of the present invention is a variation wherein a buckle is incorporated to the at least one adjustable strap 2. In this variation, the at least one adjustable strap 2 comprises a first portion and a second portion, and the buckle comprises a female and a male. The female is connected to either the first portion or the second portion of whereas the male is connected to either the first portion or the second portion. Moreover, the first portion and the second portion each has a tri-glide slide 3 attached thereto so the length of the first portion and the second portion can be adjustable. Once the female and the male of the buckle are engaged, the first portion of the at least one adjustable strap 2 is thus connected to the second portion of the at least one adjustable strap 2. With the buckle attached thereto, the length of the at least one adjustable strap 2 can be adjustable by the user adjusting the tri-glide slide 3 on each the first portion of the at least one adjustable strap 2 and the second portion of the at least one adjustable strap 2.

Along with the at least one adjustable strap 2, the present invention may comprise an at least one strap cover to accommodate the at least one adjustable strap 2. Since the at least one adjustable strap 2 is made of durable material, the at least one adjustable strap 2 needs to be covered by the at least one strap cover for extra comfort. Therefore, the at least one strap cover is made of any soft and comforting material. The at least one strap cover is a tubular cover with a cylindrical hollow space. The cylindrical hollow space within the at least one strap cover is wherein the at least one adjustable strap 2 traverses therethrough so the at least one adjustable strap 2 can be completely covered by the at least one strap cover. The at least one strap cover fully covers and sheathes the at least one adjustable strap 2 and beyond. Particularly, the at least one strap cover completely covers both the upper attachment mechanism 14 and the lower attachment mechanism 15 to prevent the infant from interacting with both the upper attachment mechanism 14 and the lower attachment mechanism 15 since both attachment mechanisms may be made of a stiff and non-comforting material such as metal, which can be discomforting for the infant to handle. Alternatively, instead of having the at least one strap cover sheathing the at least one adjustable strap 2, the present invention may not include the at least one cover strap by having the at least one adjustable strap 2 along with the attachment mechanisms manufactured and made of softer yet durable materials for the baby to touch.

Attached to the at least one strap cover is an at least one toy string 6. The at least one toy string 6 connects an at least one toy 4 to the at least one strap cover, which sheathes the at least one adjustable strap 2. With the at least one toy string 6 attached, the at least one toy 4 will always be connected to the present invention so the infant may play with the toy while the infant is being bottle fed. The at least one toy 4 further comprises an at least one toy fastener 5, which allows the at least one toy 4 to be removably attached to the at least one strap cover. The at least one toy fastener 5 may be removably attached or permanently attached to the at least one toy 4. In the preferred embodiment, the present invention does not comprise the at least strap cover since the at least one adjustable strap 2 is made of soft, durable, and comforting materials. Furthermore, the attachment mechanisms attached to the at least one adjustable strap 2 are also made of safe, non-toxic, and non-abrasive materials for the baby to touch. Specifically, the attachment mechanisms are made of soft yet durable plastics or variations thereof. In the preferred embodiment as shown from FIG. 1 to FIG. 6, the at least one toy 4 is directly attached to the at least one adjustable strap 2. Attached to the back of the at least one toy 4 is the at least one toy fastener 5, which allows the at least one toy 4 to be attached to the at least one adjustable strap 2 when the at least one toy 4 is not used by the baby. Furthermore, the at least one toy fastener 5 also allows the at least one toy 4 to be attached to the baby bottle pouch 1, visibly in sight for the baby to touch and play with. When the baby wants to only play with the baby bottle or the baby bottle pouch 1, the at least one toy 4 may be removed away from the baby bottle pouch 1 by the user detaching the at least one toy fastener 5 from the baby bottle pouch 1. The at least one toy 4 is preferably a soft child's toy such as a stuffed animal that is comforting for the infant to play with and hold. The at least one toy fastener 5 comprises components selected from the group consisting of clips, hooks, loops, rings, clasps, snap-on fasteners, buttons, and the like made in soft plastics. The at least one toy 4 can be connected to the at least one adjustable strap 2 via the at least one toy string 6, which is also connected to the at least one adjustable strap 2. The at least one toy fastener 5 attached to the at least one toy 4 may not only be attached to the baby bottle pouch 1 but also to the at least one adjustable strap 2 as well.

The present invention further comprises the method of use thereof. The method of utilizing a baby bottle holder is initiated by a user placing a baby bottle centrally in a baby bottle pouch 1 of a baby bottle holder with a nipple of the baby bottle uncovered by the baby bottle pouch 1. Then, the user may secure a baby bottle body inside the baby bottle pouch 1 by pulling on a drawstring 8 of the baby bottle pouch 1 or strapping an elastic band of the baby bottle pouch 1 around a cap ring of the baby bottle. In securing the baby bottle body within the baby bottle pouch 1, the baby bottle body may be secured to the baby bottle pouch 1 by a bottle locking mechanism 10. There are various bottle locking mechanisms as described heretofore, and the present invention may comprise a bottle locking mechanism 10 such as threading, snapping, or strapping in other alternative embodiments. The user may then position the baby bottle and the baby bottle pouch 1 across a chest of the user by adjusting an at least one adjustable strap 2 and positioning the at least one adjustable strap 2 across a back of the user. The at least one adjustable strap 2 may be adjusted by the user sliding the tri-glide slide 3 along the length of the at least one adjustable strap 2. The at least one adjustable strap 2 may be a plurality of straps. Afterwards, the user may clutch the infant in both arms of the user and position the infant close to the baby bottle and the baby bottle pouch 1 for feeding. Upon positioning the infant close to the baby bottle, it is necessary the nipple of the baby bottle be clearly visible to the infant so the infant may suck onto and be fed. It is understood that in the present invention the baby bottle may be permanently attached or connected to the baby bottle pouch 1.

Although the invention has been explained in relation to its preferred embodiment, it is to be understood that many other possible modifications and variations can be made without departing from the spirit and scope of the invention as hereinafter claimed.

What is claimed is:

1. A baby bottle holder comprises,
a baby bottle pouch;
an at least one adjustable strap;
the baby bottle pouch comprising an adjustable open end, a drawstring, a pouch base, a bottle locking mechanism, a lining layer, a filling layer, and an external cover;
an at least one toy;
an at least one toy string; and
an at least one toy fastener.

2. The baby bottle holder as claimed in claim 1 comprises,
the at least one adjustable strap being connected to the baby bottle pouch.

3. The baby bottle holder as claimed in claim 1 comprises,
the drawstring being sheathed by the adjustable open end;
the bottle locking mechanism being positioned within the baby bottle pouch; and
the bottle locking mechanism being positioned upon the pouch base.

4. The baby bottle holder as claimed in claim 1 comprises,
the at least one toy being attached to the at least one adjustable strap;
the at least one toy being attached to the at least one adjustable strap via the at least one toy string;
the at least one toy string being connected to the at least one adjustable strap;
the at least one toy fastener being attached to the at least one toy; and
the at least one toy being attached to the at least one adjustable strap via the at least one toy fastener.

5. The baby bottle holder as claimed in claim 1, wherein the bottle locking mechanism can be one of the various bottle locking mechanisms include but are not limited to threading, snapping, and strapping.

6. The baby bottle holder as claimed in claim 1, wherein the external cover of the baby bottle pouch may be in various customized shapes including but are not limited to that of an animal, oval, circle, square, rectangle, and an irregular shape.

7. A baby bottle holder comprises,
a baby bottle pouch;
an at least one adjustable strap;
the baby bottle pouch comprising an adjustable open end, a drawstring, a pouch base, a bottle locking mechanism, a lining layer, a filling layer, and an external cover;
an at least one toy;
an at least one toy string; and
an at least one toy fastener.

8. The baby bottle holder as claimed in claim 7 comprises,
the at least one adjustable strap being attached to the baby bottle pouch; and
the at least one adjustable strap comprising a tri-glide slide.

9. The baby bottle holder as claimed in claim 7 comprises,
the drawstring being sheathed by the adjustable open end;
the bottle locking mechanism being positioned within the baby bottle pouch; and
the bottle locking mechanism being positioned upon the pouch base.

10. The baby bottle holder as claimed in claim 7 comprises,
the at least one toy being attached to the at least one adjustable strap;
the at least one toy being attached to the at least one adjustable strap via the at least one toy string;
the at least one toy string being connected to the at least one adjustable strap;
the at least one toy fastener being attached to the at least one toy; and
the at least one toy being attached to the at least one adjustable strap via the at least one toy fastener.

11. The baby bottle holder as claimed in claim 7, wherein the baby bottle pouch and the at least one adjustable strap are made of a soft fabric material.

12. The baby bottle holder as claimed in claim 7, wherein the bottle locking mechanism can be one of the various bottle locking mechanisms include but are not limited to threading, snapping, and strapping.

13. The baby bottle holder as claimed in claim 7, wherein the external cover of the baby bottle pouch may be in various customized shapes including but are not limited to that of an animal, oval, circle, square, rectangle, and an irregular shape.

14. The baby bottle holder as claimed in claim 8, wherein an attachment mechanism between the at least one adjustable strap and the baby bottle pouch comprises components selected from the group consisting of clips, hooks, loops, rings, clasps, and fasteners.

15. The baby bottle holder as claimed in claim 14, wherein the attachment mechanism is composed of a non-toxic, non-abrasive, and durable elastic material.

16. A method of utilizing a baby bottle holder comprises the steps of:
a) placing a baby bottle centrally in a baby bottle pouch of a baby bottle holder with a nipple of the baby bottle uncovered by the baby bottle pouch;
b) securing a baby bottle body inside the baby bottle pouch by pulling on a drawstring of the baby bottle pouch around a cap ring of the baby bottle or strapping an elastic band of the baby bottle pouch around the cap ring of the baby bottle;
c) positioning the baby bottle and the baby bottle pouch across a chest of a user by adjusting an at least one adjustable strap and positioning the at least one adjustable strap over a shoulder and across a back of the user; and
d) clutching an infant in with either arm or either hand of the user and positioning the infant close to the nipple of the baby bottle and the baby bottle pouch for feeding.

17. The method of utilizing the baby bottle holder as claimed in claim 16, wherein step (b) includes securing the baby bottle body inside the baby bottle pouch by a bottle locking mechanism.

18. The method of utilizing the baby bottle holder as claimed in claim 17, includes various bottle locking mechanisms include but are not limited to threading, snapping, and strapping.

19. The method of utilizing the baby bottle holder as claimed in claim 16, wherein the at least one adjustable strap may be a plurality of straps.

20. The method of utilizing the baby bottle holder as claimed in claim 16, wherein the baby bottle may be connected to the baby bottle pouch.
